(19) United States
(12) Patent Application Publication
(10) Pub. No.: US 2023/0303092 A1
(43) Pub. Date: Sep. 28, 2023

(54) PERCEPTION ERROR IDENTIFICATION

(71) Applicant: GM Cruise Holdings LLC, SAN FRANCISCO, CA (US)

(72) Inventor: Feng Tian, Foster City, CA (US)

(21) Appl. No.: 17/706,055

(22) Filed: Mar. 28, 2022

(51) Int. Cl. B60W 50/02

(52) U.S. Cl. CPC B60W 50/0205; B60W 60/00

(57) ABSTRACT

The disclosed technology provides solutions for validating/verifying perception outputs, e.g., from a perception module of an autonomous vehicle (AV) software stack. In some aspects, a process of the disclosed technology can include steps for providing sensor data to a perception module, receiving, from the perception module, a first perception output based on the sensor data, providing the sensor data to a validation module, and receiving, from the validation module, a second perception output based on the sensor data. In some aspects, the process can further include steps for determining if the first perception output corresponds with the second perception output. Systems and machine-readable media are also provided.

### BACKGROUND

### 1. Technical Field

The disclosed technology provides solutions for identifying perception errors and in particular, for identifying autonomous vehicle perception module errors using one or more independent perception validation modules.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to passenger pick-up and drop-off.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 conceptually illustrates an example system for validating perception outputs, e.g., of a perception module, according to some aspects of the disclosed technology.

FIG. 2 illustrates a flowchart of an example process for determining when to perform further verification/validation of a perception output, according to some aspects of the disclosed technology.

FIG. 3 illustrates a flow diagram of an example process for implementing validating a perception output, e.g., from a perception module of an autonomous vehicle stack, according to some aspects of the disclosed technology.

FIG. 4 illustrates a flow diagram of an example process for determining/identifying a ground-truth perception output using a multitude of perception modules, according to some aspects of the disclosed technology.

FIG. 5 illustrates an example system environment that can be used to facilitate autonomous vehicle (AV) dispatch and operations, according to some aspects of the disclosed technology.

FIG. 6 illustrates an example of a deep learning neural network that can be used to implement a perception module and/or one or more validation modules, according to some aspects of the disclosed technology

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

To perform perception, prediction and planning operations, autonomous vehicles (AVs) typically collect and process sensor data corresponding with a surrounding environment. For example, sensor data can be collected using various AV sensors, including but not limited to one or more cameras, Light Detection and Ranging (LiDAR), sensors, radar sensors, and/or inertial measurement units (IMUs), or the like. In typically AV systems, collected sensor data is first provided to a perception module (or perception layer) of the AV software stack, which is used to identify various objects and environmental features from the sensor data. Downstream from the perception module, identified environmental objects/features are provided to the prediction and planning layers of the AV stack, which are used by the AV to reason about how to safely navigate the environment.

Because perception processing is often upstream from other AV processing tasks, it is important that perception module outputs are as accurate as possible, e.g., to prevent the proliferation of errors in downstream processes. Aspects of the disclosed technology provide solutions for identifying potential perception errors, and for escalating identified errors for further revision, e.g., by a human technician.

In some aspects, perception outputs can be corroborated using one or more ancillary perception or validation modules, e.g., that are configured to generate perception outputs independently from the vehicle's main perception process. In some aspects, the validation modules can be independently configured and/or trained. For example, each validation module may include (or may be) a machine-learning model (or network, e.g., a deep-learning network), that has been trained using different training data. Additionally, each validation module may include machine-learning models that are configured to have other differences, such as different network architectures.

In some aspects, a true or accepted “ground-truth” perception output can be identified. In such approaches, the ground-truth perception output can represent the most accurate or more likely accurate perception output. Ground-truth perception outputs can be identified/determined based on a comparison of perception outputs from multiple perception modules, e.g., from an AV perception module, and one or more validation modules. In such approaches a consensus rule (or consensus algorithm) may be used to determine/identify the ground-truth output. As discussed in further detail below, consensus approaches may utilize a voting mechanism, e.g., in which the ground-truth perception output is determined to be one that garners the most support, or a majority of support amongst perception module outputs.

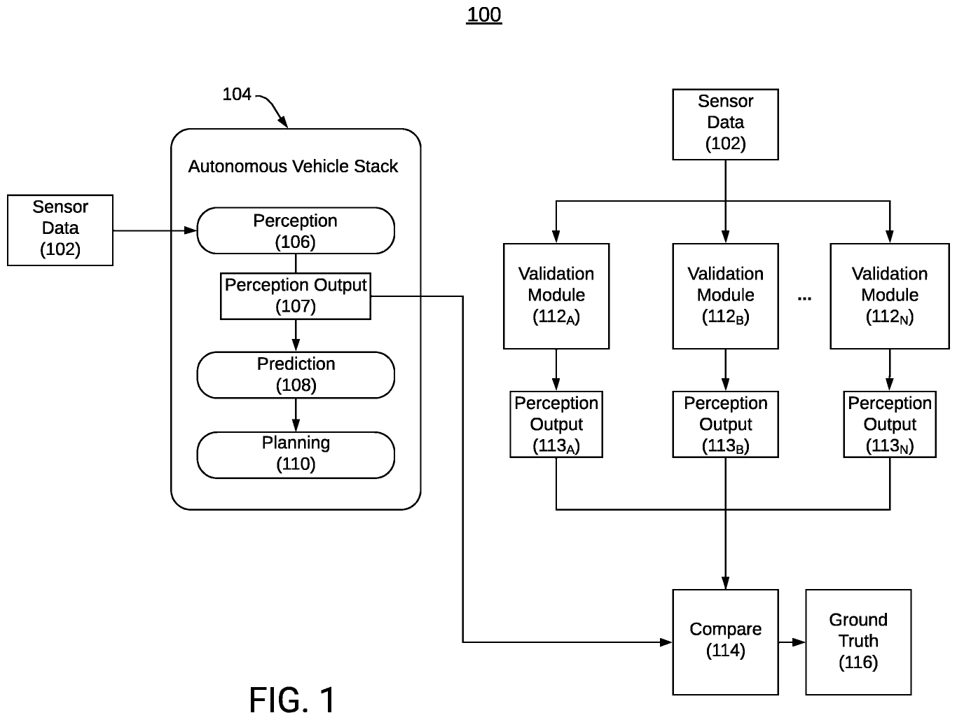

FIG. 1 conceptually illustrates an example system 100 for validating perception outputs, e.g., of a perception module. System 100 includes the collection of sensor data 102, which can include one or more sensor data types. By way of example, sensor data 102 can include camera, LiDAR, radar, and/or accelerometer (IMU) data, etc. Additionally, sensor data can include metadata and other information reflecting details about the collected sensor data, such as a time and/or location that data collection occurred.

Sensor data 102 can be provided to an AV stack, e.g., AV stack 104, that includes modules for perception 106, prediction 108, and planning 110. As illustrated, sensor data 102 provided to the AV stack 104 is received by perception module 106 and used to generate a perception output 107. In this context, perception output 107 represents AV perception of the environment, based on the collected sensor data 102. By way of example, perception output 107 may identify objects, such as vehicles, pedestrians and/or roadway features in the environment around the AV.

Independently, sensor data 102 can also be provided to one or more validation modules, e.g., validation modules 112A-N. It is understood that any number of validation modules may be implemented, without departing from the scope of the disclosed technology. In practice, perception outputs from different modules can be compared, for example, to identify the existence of errors in the output of perception module 106. As used herein, perception errors can include false negatives (or false negative errors), e.g., wherein an existing object or feature is not represented (or not accurately) represented in the perception output 107. Perception errors can also include false positives, e.g., wherein an object represented in the perception output 107 does not exist in the sensed environment.

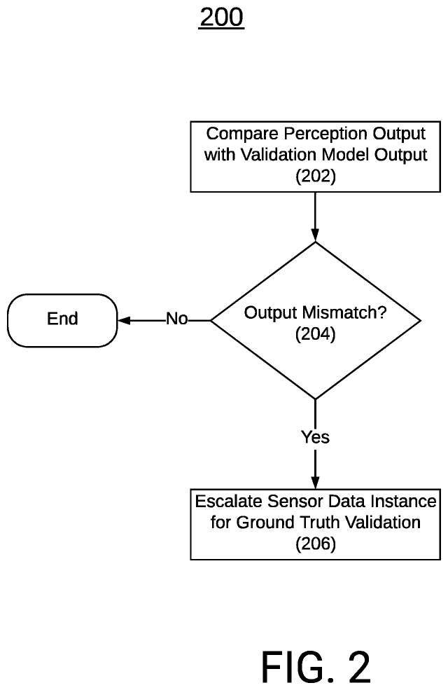

Outputs from the AV perception module 106 can be compared against perception outputs from one or more of validation module/s 112, e.g., to identify errors in the perception output 107. In some approaches, a mismatch between the perception output 107, and the validation module perception output 113 can be compared to see if any discrepancy exists. As discussed in further detail with respect to FIG. 2, discrepancies in perception module outputs, e.g., differences between perception output 1078 and one or more of perception outputs 113, can be used to determine whether the output data and/or input sensor data 102 should be further reviewed, e.g., by a human technician or labeler.

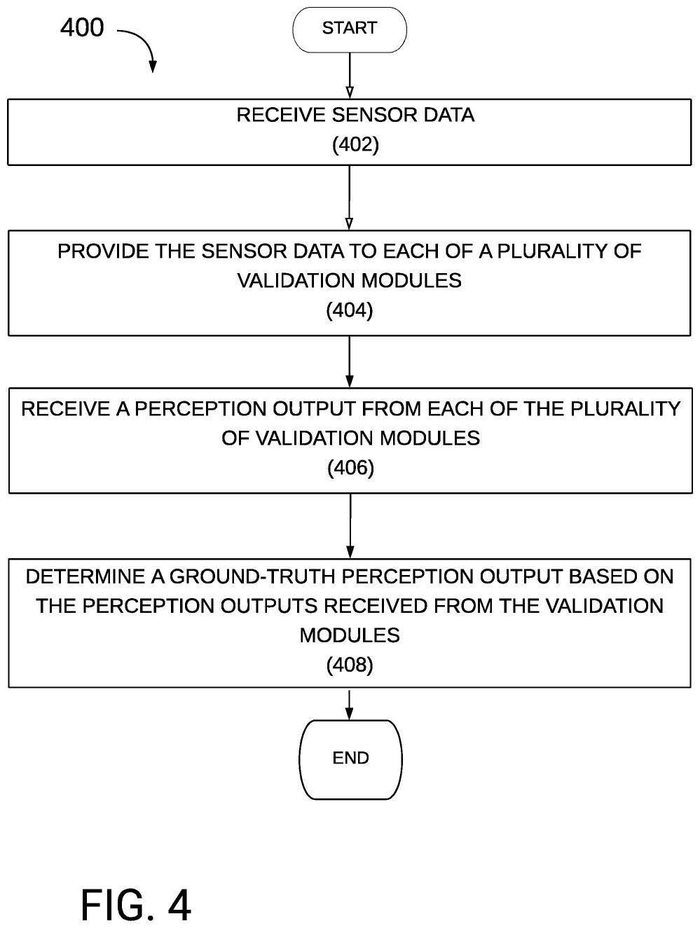

In some aspects, the multitude of perception module outputs, e.g., including perception output 107 and perception outputs 113 can be used to determine what output is the most accurate or ground-truth. As discussed in further detail with respect to FIG. 4, ground-truth determinations can be made using a consensus rule, such as a voting rule, or other consensus approach. By way of example, voting rules may include an equally weighted voting mechanism, e.g., whereby each perception module output is given an equal weighting when compared to the outputs (or votes) from other/different perception modules. In other aspects, a weighted voting approach may be used. For example, perception outputs could be weighted based on performance, e.g., using precision/recall metrics, whereby outputs from historically more accurate perception modules are given greater weight (or greater influence) during the voting process.

FIG. 2 illustrates a flowchart of an example process 200 for determining when to perform further verification/validation of a perception output. Process 200 begins with block 202 in which the perception output of the AV stack (e.g., perception output 107) is compared with perception outputs from one or more validation modules (e.g., perception output/s 113). Subsequently, it is determined if there is a mismatch between the compared outputs, e.g., the AV perception output and the validation module output. In some approaches, the determination as to the existence of a discrepancy between outputs can be based on a predetermined similarity threshold. For example, if the AV perception output and the validation perception output share above a 90% similarity, it may be determined that no discrepancy exists. It is understood that the predetermined similarly threshold can be based on the type of objects/artifacts indicated in the perception output.

As indicated in the example process 200, if it is determined that there is no difference (discrepancy) between the perception output and the validation module output, the process may be concluded (end). Alternatively, if a discrepancy is detected, e.g., due to a detected similarity between the perception output and the validation module output that is below the similarity threshold, then process 200 can advance to block 206, in which the sensor data instance that resulted in the mismatch is escalated to a review workflow, e.g., for further review. In some instances, review can be performed by a human technician or labeler, e.g., to identify the type of error (false positive, false negative, or inaccurate perception) that was detected in the perception output.

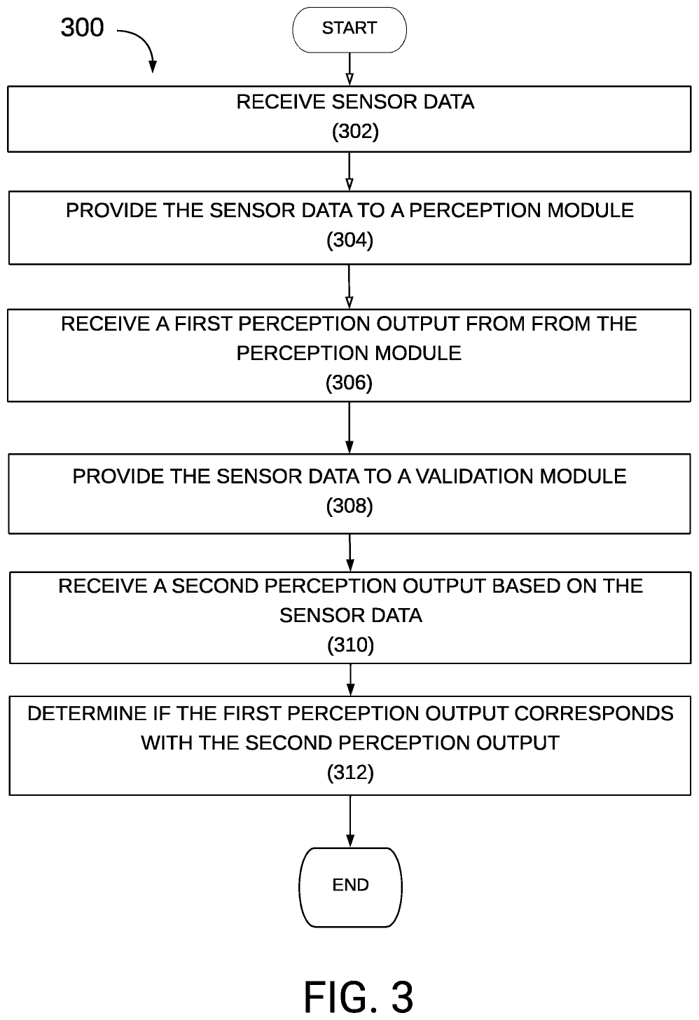

FIG. 3 illustrates a flow diagram of an example process 300 for validating a perception output. At step 302, the process 300 includes receiving sensor data, e.g., from one or more AV sensors. As discussed above, the sensor data can be collected using one or more camera, LiDAR and/or other AV sensors. In some instances, the sensor data may be received from a storage device, such as a sensor data repository or database.

At step 304, the process 300 includes providing the sensor data to a perception module, such as perception module 106 discussed above with respect to AV stack 104. As discussed above, the perception module can be (or can include) a machine-learning model/network, e.g., that is configured to perform perception operations, such as by identifying and/or labeling objects or environmental characteristics described by the received sensor data.

At step 306, the process 300 includes receiving a first perception output from the perception module. The first perception output can include data that identifies objects (e.g., vehicles, pedestrians, road signs, etc.), and/or environmental characteristics (e.g., intersections, roadways, lane boundaries, etc.), described by the received sensor data.

At step 308, the process 300 includes providing the sensor data to a validation module. As discussed above with respect to FIG. 1, the validation module can include (or can be) a machine-learning model configured to perform perception related tasks. In some approaches, the validation module can be separate and independent from the validation module. For example, the validation module may be independently trained using different training data than was used to train the perception module. Additionally, the validation model may use a different machine-learning architecture than the perception module.

At step 310, the process 300 can include receiving a second perception output, e.g., from the validation module, based on the sensor data. The second perception output can include data identifying objects (e.g., vehicles, pedestrians, road signs, etc.), and/or environmental characteristics (e.g., intersections, roadways, lane boundaries, etc.) in the sensor data.

At step 312, the process 300 can include determining if the first perception output corresponds with the second perception output. In some aspects, the first perception output can be compared with the second perception output, e.g., to determine a degree of similarity. As discussed above, a predetermined similarity threshold may be used to determine if the first/second perception outputs are determined to correspond, or if they are determined to be different. By way of example, first/second perception outputs that share a similarly that exceeds the predetermined similarity threshold may be deemed to be the same or deemed to correspond. However, first/second perception outputs that share a similarity that is below the similarity threshold may be deemed to be different or to not correspond.

As discussed above with respect to FIG. 2, where discrepancies are found between perception outputs (e.g., between outputs of an AV perception module and one or more validation modules), the perception and/or sensor data instance may be selected for further review. That is, discrepancies in perception outputs can trigger further workflows that surface the relevant perception and/or sensor data for further review, e.g., by a human technician or labeler. Alternatively, as discussed above, perception outputs from multiple validation modules may be used to determine which perception is deemed to be ground-truth. Further details regarding the use of multiple validation module outputs is provided with respect to FIG. 4, below.

FIG. 4 illustrates a flow diagram of an example process 400 for determining/identifying a ground-truth perception output using a multitude of perception modules. Process 400 begins with step 402 which includes receiving sensor data, e.g., from one or more AV sensors. As discussed above, the sensor data can be collected using one or more camera, LiDAR and/or other AV sensors. In some instances, the sensor data may be received from a storage device, such as a sensor data repository or database.

At step 404, the process 400 can include providing the sensor data to each of a plurality of validation modules. In some instances, each of the plurality of validation modules can be separate and independent. For example, the validation modules can be trained using different training data sets, and/or different training procedures. For examples, one or more of the validation modules may be trained and/or updated off-line, with greater access to training data, e.g., that is collected from multiple fleet AVs.

At step 406, the process 400 includes receiving a perception output from each of the plurality of validation modules. Each of the received perception outputs can be based on the same sensor data (or sensor data instance), for example, that represents a common representation of an environment around an AV, including various objects, such as traffic participants, and non-traffic participants, etc.

At step 408, the process 400 can include determining a ground-truth perception output, based on the perception outputs received from the validation modules (step 406). Depending on the desired implementation, a consensus mechanism may be used to identify/determine the ground-truth perception output from among the various perception output candidates. For example, perception outputs from each validation module may scored using a voting rule, e.g., where a majority consensus is deemed to be ground-truth. However, other consensus rules and/or algorithms may be used, without departing from the scope of the disclosed technology. By way of example, a weighted voting consensus approach may be used, whereby the influence (or weight) of any given perception output is based on various considerations, such as the amount of time that the corresponding perception (validation) module has been deployed, a historic accuracy of the associated validation module, and/or versioning information associated with the validation module, etc.

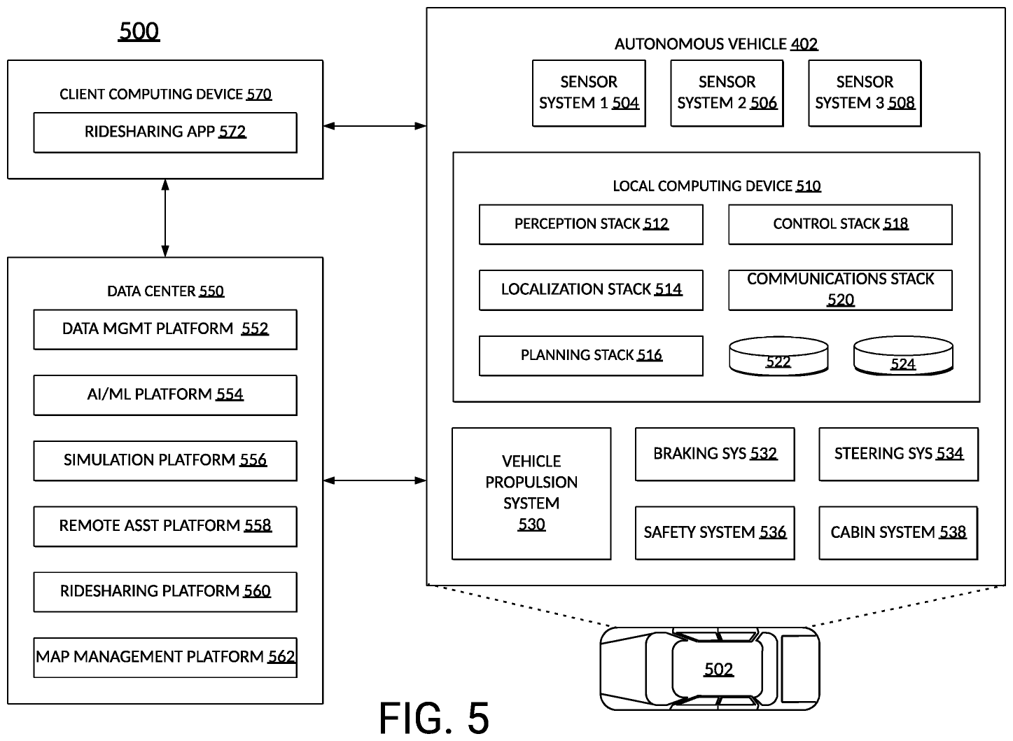

Turning now to FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 502 can navigate about roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other embodiments may include any other number and type of sensors.

AV 502 can also include several mechanical systems that can be used to maneuver or operate AV 502. For instance, the mechanical systems can include vehicle propulsion system 530, braking system 532, steering system 534, safety system 536, and cabin system 538, among other systems. Vehicle propulsion system 530 can include an electric motor, an internal combustion engine, or both. The braking system 532 can include an engine brake, brake pads, actuators, and/or any other suitable componentry configured to assist in decelerating AV 502. The steering system 534 can include suitable componentry configured to control the direction of movement of the AV 502 during navigation. Safety system 536 can include lights and signal indicators, a parking brake, airbags, and so forth. The cabin system 538 can include cabin temperature control systems, in-cabin entertainment systems, and so forth. In some embodiments, the AV 502 may not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces, e.g., Graphical User Interfaces (GUIs), Voice User Interfaces (VUIs), etc., for controlling certain aspects of the mechanical systems 530-538.

AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a planning stack 516, a control stack 518, a communications stack 520, an HD geospatial database 522, and an AV operational database 524, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 522, other components of the AV, and other data sources (e.g., the data center 550, the client computing device 570, third-party data sources, etc.). The perception stack 512 can detect and classify objects and determine their current and predicted locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth.

Mapping and localization stack 514 can determine the AV's position and orientation (pose) using different methods from multiple systems (e.g., GPS, IMUs, cameras, LIDAR, RADAR, ultrasonic sensors, the HD geospatial database 522, etc.). For example, in some embodiments, the AV 502 can compare sensor data captured in real-time by the sensor systems 504-508 to data in the HD geospatial database 522 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

The planning stack 516 can determine how to maneuver or operate the AV 502 safely and efficiently in its environment. For example, the planning stack 516 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another. The planning stack 516 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 516 can select from multiple backup plans to carry out. For example, while preparing to change lanes to turn right at an intersection, another vehicle may aggressively cut into the destination lane, making the lane change unsafe. The planning stack 516 could have already determined an alternative plan for such an event, and upon its occurrence, help to direct the AV 502 to go around the block instead of blocking a current lane while waiting for an opening to change lanes.

The control stack 518 can manage the operation of the vehicle propulsion system 530, the braking system 532, the steering system 534, the safety system 536, and the cabin system 538. The control stack 518 can receive sensor signals from the sensor systems 504-508 as well as communicate with other stacks or components of the local computing device 510 or a remote system (e.g., the data center 550) to effectuate operation of the AV 502. For example, the control stack 518 can implement the final path or actions from the multiple paths or actions provided by the planning stack 516. This can involve turning the routes and decisions from the planning stack 516 into commands for the actuators that control the AV's steering, throttle, brake, and drive unit.

The communication stack 520 can transmit and receive signals between the various stacks and other components of the AV 502 and between the AV 502, the data center 550, the client computing device 570, and other remote systems. The communication stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 520 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 522 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508 and other components of the AV 502 and/or data received by the AV 502 from remote systems (e.g., the data center 550, the client computing device 570, etc.). In some embodiments, the raw AV data can include HD LIDAR point cloud data, image data, RADAR data, GPS data, and other sensor data that the data center 550 can use for creating or updating AV geospatial data as discussed further below with respect to FIG. 2 and elsewhere in the present disclosure.

The data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and client computing device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, a ridesharing platform 560, and map management system platform 562, among other systems.

Data management platform 552 can be a “big data” system capable of receiving and transmitting data at high velocities (e.g., near real-time or real-time), processing a large variety of data, and storing large volumes of data (e.g., terabytes, petabytes, or more of data). The varieties of data can include data having different structure (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management system platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management system platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from the map management system platform 562; modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smart watch, smart eyeglasses or other Head-Mounted Display (HMD), smart ear pods or other smart in-ear, on-ear, or over-ear device, etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to be picked up or dropped off from the ridesharing application 572 and dispatch the AV 502 for the trip.

Map management system platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, UAVs, satellites, third-party mapping services, and other sources of geospatially referenced data. The raw data can be processed, and map management system platform 562 can render base representations (e.g., tiles (2D), bounding volumes (3D), etc.) of the AV geospatial data to enable users to view, query, label, edit, and otherwise interact with the data. Map management system platform 562 can manage workflows and tasks for operating on the AV geospatial data. Map management system platform 562 can control access to the AV geospatial data, including granting or limiting access to the AV geospatial data based on user-based, role-based, group-based, task-based, and other attribute-based access control mechanisms. Map management system platform 562 can provide version control for the AV geospatial data, such as to track specific changes that (human or machine) map editors have made to the data and to revert changes when necessary. Map management system platform 562 can administer release management of the AV geospatial data, including distributing suitable iterations of the data to different users, computing devices, AVs, and other consumers of HD maps. Map management system platform 562 can provide analytics regarding the AV geospatial data and related data, such as to generate insights relating to the throughput and quality of mapping tasks.

In some embodiments, the map viewing services of map management system platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

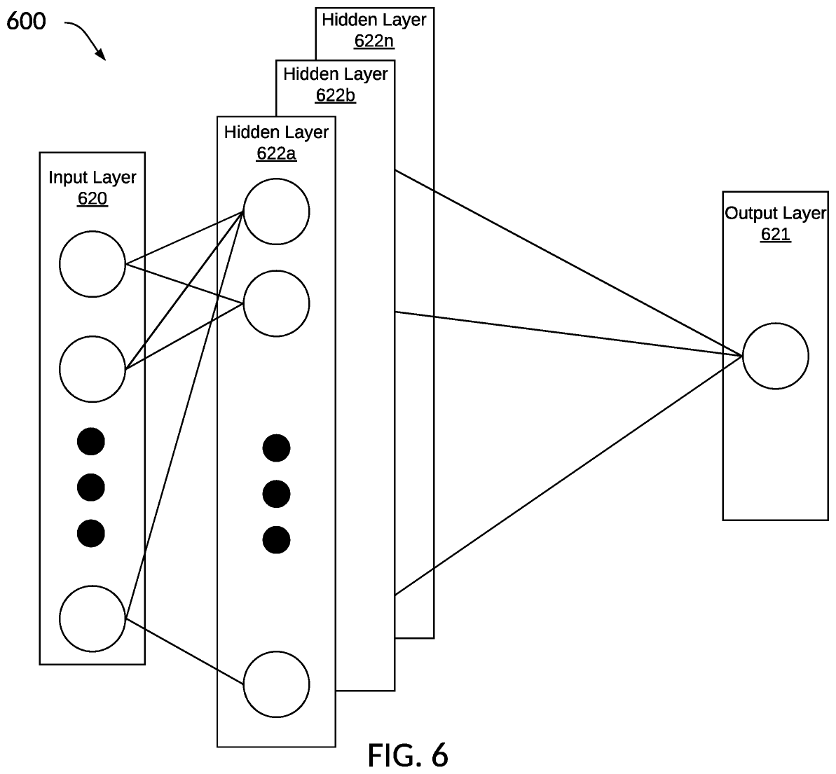

FIG. 6 The disclosure now turns to a further discussion of models that can be used through the environments and techniques described herein. Specifically, FIG. 6 is an illustrative example of a deep learning neural network 600 that can be used to implement all or a portion of a perception module (or perception system) as discussed above. An input layer 620 can be configured to receive sensor data and/or data relating to an environment surrounding an AV. The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 621 that provides an output resulting from the processing performed by the hidden layers 622a, 622b, through 622n. In one illustrative example, the output layer 621 can provide estimated treatment parameters (e.g., estimated parameters 303), that can be used/ingested by a differential simulator to estimate a patient treatment outcome.

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes (e.g., node 626) in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as

$$E\_total = \sum ( \frac{1}{2} {( target - output )}^{2} ) .$$

The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, a deep belief nets (DBNs), a Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; generative adversarial networks (GANs); support vector machines; image registration methods; applicable rule-based system. Where regression algorithms are used, they may include but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

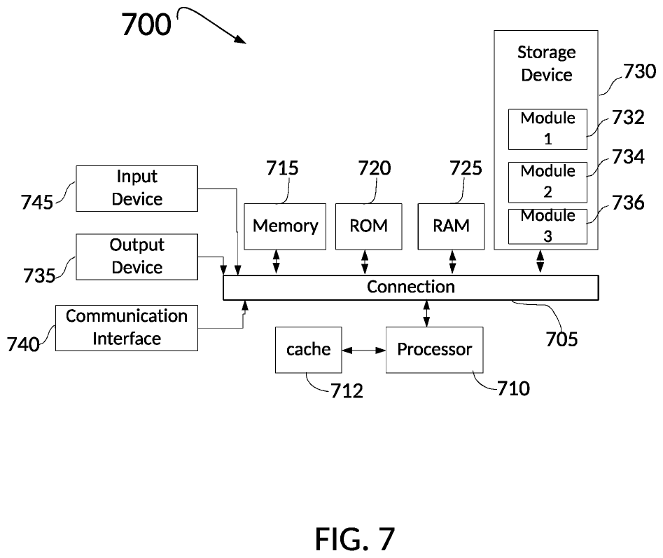

FIG. 7 illustrates an example processor-based system with which some aspects of the subject technology can be implemented. For example, processor-based system 700 can be any computing device making up internal computing system 710, remote computing system 750, a passenger device executing the rideshare app 770, internal computing device 730, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus for measuring perception error, comprising:
at least one memory; and
at least one processor coupled to the at least one memory, the at least one processor configured to:
receive sensor data, wherein the sensor data corresponds with an environment around an autonomous vehicle (AV);
provide the sensor data to a perception module;
receive, from the perception module, a first perception output based on the sensor data;
provide the sensor data to a validation module;
receive, from the validation module, a second perception output based on the sensor data; and
determine if the first perception output corresponds with the second perception output.

2. The apparatus of claim 1, wherein to determine if the first perception output corresponds with the second perception output, the at least one processor is configured to:
compare the first perception output with the second perception output.

3. The apparatus of claim 1, wherein to determine if the first perception output corresponds with the second perception output, the at least one processor is configured to:
determine if the first perception output is within a predetermined threshold of the second perception output.

4. The apparatus of claim 1, wherein the at least one processor is configured to:
flag the first perception output for further review, if the first perception output does not correspond with the second perception output.

5. The apparatus of claim 1, wherein the validation module comprises a deep-learning neural network.

6. The apparatus of claim 1, wherein the sensor data comprises camera data, Light Detection and Ranging (LiDAR).

7. The apparatus of claim 1, wherein the sensor data is received from one or more autonomous vehicle (AV) sensors.

8. A computer-implemented method for measuring perception error, comprising:
receiving sensor data, wherein the sensor data corresponds with an environment around an autonomous vehicle (AV);
providing the sensor data to a perception module;
receiving a first perception output based on the sensor data;
providing the sensor data to a validation module;
receiving a second perception output based on the sensor data; and
determining if the first perception output corresponds with the second perception output.

9. The computer-implemented method of claim 8, wherein determining if the first perception output corresponds with the second perception output, further comprises:
comparing the first perception output with the second perception output.

10. The computer-implemented method of claim 8, determining if the first perception output corresponds with the second perception output, comprises:
determining if the first perception output is within a predetermined threshold of the second perception output.

11. The computer-implemented method of claim 8, further comprising:
flagging the first perception output for further review, if the first perception output does not correspond with the second perception output.

12. The computer-implemented method of claim 8, wherein the validation module comprises a deep-learning neural network.

13. The computer-implemented method of claim 8, wherein the sensor data comprises camera data, Light Detection and Ranging (LiDAR).

14. The computer-implemented method of claim 8, wherein the sensor data is received from one or more autonomous vehicle (AV) sensors.

15. A non-transitory computer-readable storage medium comprising at least one instruction for causing a computer or processor to:
receive sensor data, wherein the sensor data corresponds with an environment around an autonomous vehicle (AV);
provide the sensor data to a perception module;
receive a first perception output based on the sensor data;
provide the sensor data to a validation module;
receive a second perception output based on the sensor data; and
determine if the first perception output corresponds with the second perception output.

16. The non-transitory computer-readable storage medium of claim 15, wherein to determine if the first perception output corresponds with the second perception output, the at least one instruction is further configured to cause the computer or processor to:
compare the first perception output with the second perception output.

17. The non-transitory computer-readable storage medium of claim 15, wherein to determine if the first perception output corresponds with the second perception output, the at least one instruction is further configured to cause the computer or processor to:
determine if the first perception output is within a predetermined threshold of the second perception output.

18. The non-transitory computer-readable storage medium of claim 15, wherein the at least one instruction is further configured to cause the computer or processor to:
flag the first perception output for further review, if the first perception output does not correspond with the second perception output.

19. The non-transitory computer-readable storage medium of claim 15, wherein the validation module comprises a deep-learning neural network.

20. The non-transitory computer-readable storage medium of claim 15, wherein the sensor data comprises camera data, Light Detection and Ranging (LiDAR).
